(19) United States
(12) Patent Application Publication
(10) Pub. No.: US 2017/0204236 A1
(43) Pub. Date: Jul. 20, 2017

(54) METHOD FOR COATING PLASTICS SUBSTRATES

(71) Applicant: BASF Coatings GmbH, Muenster (DE)

(72) Inventors: Audree ANDERSEN, Havixbeck (DE); Bjoern HEINZ, Cupertino, CA (US); Christina HAAF-KLEINHUBBERT, Hemsbach (DE); Bastian Marten NOLLER, Neuhofen (DE); Helen BRANNON, Birmingham (GB)

(73) Assignee: BASF Coatings GmbH, Muenster (DE)

(21) Appl. No.: 15/324,156

(22) PCT Filed: May 22, 2015
(86) PCT No.: PCT/EP2015/061360

§ 371 Date: Jan. 5, 2017

(30) Foreign Application Priority Data
Jul. 9, 2014 (EP) 14176258.3

(51) Int. Cl. C08J 7/04; C09D 133/08; B05D 3/10; B05D 7/02; B05D 7/26; B05D 7/00; C09D 175/04; B05D 3/06

(52) U.S. Cl. CPC C08J 7/042; C09D 175/04; C09D 133/08; B05D 3/067; B05D 7/02; B05D 7/26; B05D 7/532; B05D 3/101; C08J 2323/12

(57) ABSTRACT

The present invention relates to a method for coating plastics substrates with an aqueous coating composition (A) comprising at least one organic polymer as binder, said coating composition being applied to at least one surface (O) of the plastics substrate and being subsequently cured, wherein (i) the application of the coating composition (A) is preceded by the application of a carbene-forming compound (C) of the formula (I) below

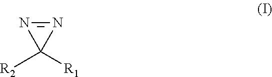

where
R₁=—(CX₂)ₙX, where X=F or Cl, and n=0 or 1,
R₂=

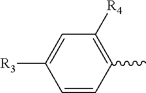

where
R₃ and R₄ independently of one another =—H, —(CH₂)ₘY,
where Y=OH, CO₂H, NH₂, or Br, and m=0 to 4,
with the exception of R₃=R₄=—H,
directly to the surface (O) and its activation to carbene formation, and/or (ii) the coating composition (A) comprises the carbene-forming compound (C), which is activated to carbene formation following application of the coating composition (A). The invention also relates to coatings produced by means of the method, and to coated plastics substrates.

The present invention relates to a method for coating plastics substrates with an aqueous coating composition. The method may find application in, for example, the automotive finishing sector, as for example in the finishing of vehicle parts and accessory vehicle parts.

### PRIOR ART

In the vehicle finishing arena, plastics have become established as materials for vehicle parts and also for parts and accessory parts for installation in or on both the interior and the exterior of vehicles. Plastics, just like other materials, are coated or finished for decorative reasons (coloring, for example) and/or for technical appropriateness (light stability and weather resistance, for example) with appropriate coating compositions. One important prerequisite for a high-quality coating is its adhesion to the substrate surface. It is widely known that sometimes serious problems of adhesion to the plastics substrate may occur particularly in the coating or finishing of plastics, especially of non-polar plastics, such as polypropylene (PP) in pure form or in a form in which it has been modified (for example, by addition of ethylene-propylene-diene copolymers (EPDM)). The adhesion problems are exacerbated when using aqueous coating compositions—whose increasing use in the coating of plastics as well is dictated by environmental issues—in particular in the context of the finishing of nonpolar plastics substrates, owing to the differences in polarity between the two media, the plastics substrate and the coating composition.

In order to achieve acceptable adhesion for the respective coating composition, nonpolar plastics of these kinds are conventionally subjected to a surface-activating pretreatment. The techniques most frequently employed are flaming, plasma treatment, and corona discharge.

Also known for improving adhesion is the use of adhesion-promoting substances, especially chlorinated polyolefins. The adhesion-promoting substances are deployed, for example, by way of adhesion primers, which comprise the adhesion-promoting substances and are applied to the plastics substrate in a separate coating operation. Likewise possible is the direct addition of adhesion-promoting substances to the coating composition that is to be used to produce the decorative and/or technically appropriate coating.

Although the adhesion properties achieved by means of the described surface-activating pretreatment are generally satisfactory, it would be advantageous, especially in the industrial vehicle finishing sector, to be able to omit the steps of the described pretreatment within the production line in the course of the finishing operation. The reason is that this pretreatment necessitates special equipment and special conditions and safety precautions. Omitting it, if possible, would be very advantageous on environmental and economic grounds.

The use of chlorinated polyolefins to improve the adhesion properties, as well, may lead to acceptable adhesion properties, but is unacceptable from an environmental standpoint. Thus, for example, in the territory of the European Union, there are already regulations prohibiting or greatly hindering the use of such substances, for reason of environmental harmfulness.

Patent application DE 199 61 983 A1 discloses a method for coating plastics, especially nonpolar plastics, with waterborne, adhesion-promoting coating materials, the coatings obtained by the method featuring effective adhesion. Prior to the application of the coating materials, however, the plastics substrate requires cleaning with at least one specific organic solvent. The coating material, moreover, comprises at least one adhesion promoter, particularly a chlorinated polyolefin.

WO 2013/064506 A1 describes a method for coating plastics substrates with an aqueous coating composition that achieves excellent adhesion. The method, though, requires a highly complex, combined pretreatment composed of heat treatment of the plastic substrate and subsequent flaming. For reasons already stated, such a method has certain disadvantages particularly in the industrial vehicle finishing sector.

### Problem Addressed by the Invention

It was an object of the present invention, accordingly, to provide a method for coating plastics substrates with an aqueous coating composition that allows plastics substrates to be provided with a coating or paint film whose adhesion to the respective plastics substrate is excellent. At the same time it was an object of the invention to be able to omit the complex customary pretreatment, more particularly the flaming, and also the use of chlorinated polyolefins. In spite of this, the outstanding adhesion properties described ought to be achieved in this situation. Although in a particular case the additional complex pretreatment and/or the use of chlorinated polyolefins may be attractive, it ought to be possible to omit such pretreatment and/or use in the context of the present invention. In the context of the method of the invention, therefore, the additional complex pretreatment (namely flaming and/or heat treatment) and the use of chlorinated polyolefins are omitted. The method, accordingly, can be deployed advantageously in particular in the context of finishing operations in which a high throughput rate is desired. Particularly noteworthy in this context is the automotive OEM finishing sector.

### Solution Provided by the Invention

In accordance with the invention the object is achieved by means of a method for coating plastics substrates with an aqueous coating composition (A) comprising at least one organic polymer as binder, said coating composition being applied to at least one surface (O) of the plastics substrate and being subsequently cured, wherein (i) the application of the coating composition (A) is preceded by the application of a carbene-forming compound (C) of the formula (I) below

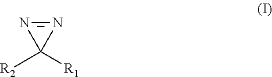

where
R₁=—(CX₂)ₙX, where X=F or Cl, and n=0 or 1,

### R₂=

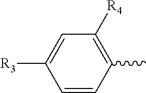

where
R₃ and R₄ independently of one another =—H, —(CH₂)ₘY,
where Y=OH, CO₂H, NH₂, or Br, and m=0 to 4,
with the exception of R₃=R₄=—H,
directly to the surface (O) and its activation to carbene formation, and/or (ii) the coating composition (A) comprises the carbene-forming compound (C), which is activated to carbene formation following application of the coating composition (A).

The method for coating plastics substrates is referred to hereinafter as method of the invention. Further, preferred embodiments of the method of the invention will become apparent from the description below.

It has been found that by means of the method of the invention and of the associated contacting of the plastics substrates with a carbene, coatings result that possess excellent adhesion to plastics substrates, especially nonpolar plastics substrates. Moreover, a conventional pretreatment of the substrate surface, such as flaming, for example, is unnecessary for achieving effective adhesion. Contacting of the carbene is accomplished in a simple way, namely by customary application of a carbene-forming compound (C) to the substrate and its subsequent activation to carbene formation, before the coating composition (A) is applied, and/or by integration of the compound (C) into the coating composition (A), the activation to carbene formation being accomplished in the latter case following the application of the coating composition (A)—for example, during the curing of the coating composition.

### General Description

### Aqueous Coating Composition (A)

An aqueous coating composition (A) is used in the context of the method of the invention that comprises at least one organic polymer as binder. Here it is possible to use the coating compositions that are familiar in this context to the skilled person. The coating composition comprises at least one organic polymer as binder. These organic polymers are, for example, the polyurethane, polyester and/or epoxy resins that are known to the skilled person. Likewise possible is the use of polyacrylate and polymethacrylate resins (identified below as poly(meth)acrylate resins) that are known per se. The stated organic polymers as binders preferably further comprise different functional groups for chemical crosslinking, with hydroxyl groups being preferred. Preference is given to polyurethane, polyester and/or poly(meth)acrylate resins containing preferably hydroxyl groups for use as binders. Organic polymers and resins of these kinds are described in Römpp-Lexikon Lacke and Druckfarben, Georg Thieme Verlag, Stuttgart, New York, 1998, pages 73 to 74, for example. The dispersibility of the organic polymers or resins in water may be implemented via the measures that are familiar to the skilled person. These measures may involve the ionic modification of the organic polymers through introduction of monomers containing, for example, carboxylate or sulfonate groups. Also possible is the nonionic modification by means, for example, of polyglycol ether chains, or the use of certain additives, described later on below, such as dispersants, examples being emulsifiers.

In the case of externally crosslinking systems, for example, in addition to the resin systems recited above, crosslinkers present in the aqueous coating composition are, in addition, fully etherified and/or partially etherified amino resins, monomeric and/or polymeric polyamines and also monomeric and/or polymeric, blocked and/or free polyisocyanates. In the context of the method of the invention it is preferred to use fully etherified and/or partially etherified amino resins, especially preferably fully etherified and/or partially etherified melamine-formaldehyde resins.

The selection and combination of suitable organic polymers and monomers, for example of suitable polyurethane, polyester, poly(meth)acrylate and/or epoxy resins with suitable functional groups, preferably hydroxyl groups, and optionally amino resins, polyamines and/or polyisocyanates takes place in accordance with the desired and/or required properties of the coating system to be produced. Another criterion for selection are the desired and/or required curing conditions, more particularly the curing temperatures. The way in which such a selection is to be made is known to the skilled person in the art and may be adapted accordingly by this skilled person. Possibilities here include the one-component and also two-component coating systems that are known per se (in this regard see also Römpp-Lexikon Lacke and Druckfarben, Georg Thieme Verlag, Stuttgart, New York, 1998, pages 274-276, and also pages 641-642). Preference is given to the use of one-component systems.

Particularly preferred in the context of the method of the invention is the use of a combination of at least one hydroxy-functional polyurethane, polyester and/or poly(meth)acrylate resin as binder and at least one fully etherified and/or partially etherified melamine-formaldehyde resin as crosslinker.

The fraction of all the film-forming components, more particularly of the at least one hydroxy-functional polyurethane, polyester and/or poly(meth)acrylate resin as binder and of the at least one fully etherified and/or partially etherified melamine-formaldehyde resin as crosslinker, is advantageously in the range from 10 to 90% by weight, more particularly from 15 to 60% by weight, very preferably in the range from 20 to 50% by weight, based in each case on the total amount of the aqueous coating composition. The fraction of a resin as binder and of a crosslinker, considered separately in each case, is advantageously not below 3% by weight, based on the total amount of the aqueous coating composition.

The aqueous coating composition (A) may further comprise at least one customary and known coloring and/or effect-imparting pigment. The coating composition advantageously comprises at least one pigment.

Examples of such pigments are inorganic-based pigments, such as titanium dioxide, iron oxide and carbon black, for example, or else customary metallic pigments (examples being commercial aluminum bronzes, stainless steel bronzes) and nonmetallic effect pigments (examples being pearlescent pigments and interference pigments). Organic-based coloring pigments as well, such as azo pigments and phthalocyanine pigments, may be employed. The pigments fraction in the coating composition is situated for example in the range from 0 to 20% by weight, preferably 2 to 15% by weight, based in each case on the total amount of the aqueous coating composition. The nature and amount to be used of pigments are selected in the manner familiar to the skilled person, the selection being guided by the required or desired properties of the coating composition. As a supplement in this regard, reference may be made to Römpp-Lexikon Lacke and Druckfarben, Georg Thieme Verlag, Stuttgart, New York, 1998, page 451.

Besides water, the aqueous coating compositions (A) may further comprise organic solvents as well. Present may be, for example, aliphatic and/or aromatic hydrocarbons such as toluene, xylene, solvent naphtha, Solvesso 100, Shellsol A, ketones such as acetone, methyl ethyl ketone or methyl amyl ketone, esters, such as ethyl acetate, butyl acetate, pentyl acetate or ethyl ethoxypropionate, ethers such as butylglycol, dipropylene glycol methyl ether, alcohols such as ethylhexanol, butoxypropanol, isopropanol or butyldiglycol, or mixtures of the aforementioned solvents. It is preferred to use water-miscible organic solvents.

The coating composition (A) to be used is aqueous. Aqueous is a particularization, familiar to the skilled person, of coating compositions which as solvents comprise not exclusively organic solvents, but instead are also based on water as solvent. Aqueous in the context of the present invention means more particularly that the coating composition contains at least 10% by weight, preferably at least 20% by weight, very preferably at least 25% by weight of water, based in each case on the total amount of the coating composition. With particular preference, aqueous should be understood to mean that, in addition to the stated requirement of “at least 10% by weight (or at least 20 or 25% by weight) of water, based on the total amount of the coating composition”, a further requirement to be met is that the fraction of organic solvents in the coating composition is less than 25% by weight, more particularly less than 20% by weight, based in each case on the total amount of the coating composition.

Furthermore, in the aqueous coating composition (A), there may be at least one coatings additive present that is known per se. Such coatings additives are for example, but not exclusively,
defoamers,
reactive diluents,
polymerization inhibitors,
slip additives,
wetting agents such as siloxanes, fluorine-containing compounds, carboxylic monoesters,
catalysts, such as acidic, phosphorus-containing catalysts based on, for example, substituted phosphonic diesters or substituted phosphoric esters,
flow control agents,
rheology control additives,
dispersants,
UV stabilizers,
fillers such as silicon dioxide, aluminum silicate or barium sulfate,
and/or flame retardants.

Coatings additives of these kinds are available in commerce from various suppliers, for example. The fraction of a particular additive is advantageously not more than 10% by weight, more particularly not more than 5% by weight, with particular preference not more than 3% by weight, based in each case on the total amount of the aqueous coating composition. Preferably the aqueous coating composition is substantially free from chlorinated polyolefins. In the context of the present invention, “substantially free from” in relation to any particular substance(s) should be understood to mean that the aqueous coating composition contains not more than 5% by weight, more particularly not more than 2.5% by weight, with particular preference not more than 2.0% by weight, very preferably not more than 1.0% by weight, of the substance(s) in question, based in each case on the total amount of the coating composition. In one especially preferred embodiment the aqueous coating composition is completely free from chlorinated polyolefins.

The coating composition may also comprise at least one carbene-forming compound (C) as described in more detail later on below. In this case the coating composition may comprise the carbene-forming compound (C) in its original form (see formula (I)). It is also possible for a compound (C) to be covalently linked beforehand, in order to acquire its capacity for carbene formation, with a further component present in the coating composition (A). This embodiment is expressly embraced by the present invention when it is stated that the coating composition (A) comprises the carbene-forming compound (C). The reason is that the capacity for carbene formation is retained, and, moreover, the compound (C), although in a form in which it is now linked, is still present in the coating composition. An example would be the reaction of a polyisocyanate used in the coating composition (A) with a hydroxy-functional or amino-functional compound (C). Linking in this case takes place in a conventional way through formation of a urethane or urea function.

If present, the fraction of the carbene-forming compound (C), based in each case on the total amount of the aqueous coating composition (A), is situated for example in the range from 0.1 to 10 wt %. In the variant in which a compound (C) reacted as described is employed, the fraction, accordingly, is calculated with account being taken of the amount of the compound (C) that is used in the reaction.

The aqueous coating composition is more particularly an aqueous basecoat material. A basecoat material, as is known, is a pigmented coating composition which can be used especially in automotive finishing, but also in general industrial coating, for the purpose of constructing a color-imparting coating, more particularly a color-imparting intermediate coating as part of a multicoat paint system on, for example, a plastics substrate. Constructed atop the intermediate coating thus constructed is then frequently a clearcoat, thereby producing the classic multicoat coating system.

Viewed in terms of its method, the preparation of the aqueous coating composition, more particularly of the aqueous basecoat material, has no particular features, but instead takes place in accordance with the customary and known techniques with the aid of customary and known mixing assemblies such as stirred tanks or dissolvers.

### Plastics Substrates

The plastics substrates to be coated or finished by the method of the invention are substrates of customary plastics such as, for example, polystyrene (PS), polyvinyl chloride (PVC), polyurethane (PU), glass fiber-reinforced unsaturated polyesters, polymethyl methacrylate (PMMA), polyphenylene sulfide (PPS), polyoxymethylene (POM), polyphenylene ethers (PPE), polyphenylene oxide (PPO), polyurea, polybutadiene terephthalate (PBT), polycarbonate (PC), acrylonitrile-butadiene-styrene copolymers (ABS), polyolefins such as polypropylene (PP), optionally modified with ethylene-propylene-diene copolymers (EPDM), and also ethylene-propylene rubber (EPR). Also possible in this context are plastics substrates which comprise various of the plastics stated, hence mixtures of these plastics.

The method of the invention can be used with particular advantage for coating nonpolar plastics, such as, in particular, polyolefins such as PP and PP modified with EPDM fractions. The modification of PP with EPDM serves essentially to elastify the plastic and also has the effect, among others, of determining the paintability. With low EPDM fractions, the paintability or the adhesion is generally poor. Only with EPDM fractions of about 20 to 25% by weight are the plastics generally no longer referred to in the prior art as being difficult to paint. The method of the invention, however, may be used with very particular advantage for the painting of polypropylene/EPDM plastics having low EPDM fractions of, for example, not higher than 25% by weight, more particularly not higher than 10% by weight. Very preferably it may be employed in the coating of pure polyolefin, more particularly polypropylene. Whereas coating methods of the prior art, especially methods involving pretreatment by flaming, achieve effective adhesion only, critically, through a significant fraction of carbon-carbon double bonds introduced by the EPDM, there is—surprisingly—no need for such a fraction in the context of the present invention. Without wishing to be bound by any particular theory, it is assumed that the carbenes formed as part of the method of the invention enter, as highly reactive compounds, at least partly into covalent linkages with the plastics surface, and do so even when there are no carbon-carbon double bonds in the plastics matrix. As a result of the covalent linking, a surface modification is then obtained which then contributes to the improved adhesion of the subsequent coating. Preferred plastics substrates are therefore polyolefin plastics substrates.

The plastics substrates may be simple plastics sheets. Also possible as substrates, however, are vehicle bodies made of plastics, or certain vehicle parts, and also vehicle accessory parts and vehicle parts for installation in or on vehicles, for both the vehicle interior and vehicle exterior areas.

### Carbene-Forming Compound (C)

The carbene-forming compound (C), which as described above is present in the coating composition (A) and/or which as described below is applied directly to the surface of the plastics substrate before the coating composition is applied, has the formula (I) below:

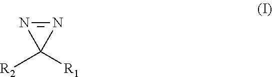

where
R₁=—(CX₂)ₙX, where X=F or Cl, and n=0 or 1,

### R₂=

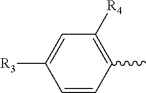

where
R₃ and R₄ independently of one another =—H, —(CH₂)ₘY,
where Y=OH, CO₂H, NH₂, or Br, and m=0 to 4,
with the exception of R₃=R₄=—H.

The compounds (C) are accordingly diazo compounds, and to put it more precisely each have a diaziridine group. The diazirine group, as is known, is a functional group which is able, by thermolysis or photolysis and corresponding elimination of a nitrogen molecule, to form a carbene. Accordingly, in the context of the present invention, according to definition and for greater ease of comprehension, the compounds (I) are also termed carbene-forming compounds. By definition, accordingly, activation to carbene formation means that a compound of this kind is exposed to corresponding conditions which are able to lead to the thermolysis and/or photolysis (that is, thermal energy and/or electromagnetic radiation such as UV radiation are/is supplied), with the compound (C) reacting to form the carbene. In the context of the present invention, preference is given to photolytic activation, in other words activation by exposure to electromagnetic radiation, more particularly UV radiation. This form of activation results in a particularly effectively adhering coating. More in-depth elucidation of the activation follows later on below.

Radical R₁ in the compound (C) is an evidently electron-withdrawing group, as for example a CF₃ group (groups having correspondingly negative inductive effect (—I effect)). Suitable radicals R₁ as per the formula above are the halogen-containing radicals —CF₃ and —CCl₃ and the halide radicals —F and —Cl. The respective radical R₁ is then attached on the carbon atom of the three-membered ring comprising the diaziridine group. Preferably R₁ is CF₃ or Cl, very preferably CF₃.

The compound (C) additionally has a substituted phenyl radical R₂, which is likewise attached on the carbon atom of the three-membered ring comprising the diaziridine group. The phenyl radical, considered from the carbon atom of the phenyl ring on which the diaziridine ring is attached, is substituted in ortho- and/or para-position. Substituted, in harmony with the customary terminology in this context, means that in the present case, in ortho- and/or para-position on the corresponding carbon atom of the phenyl ring, there is a nonhydrogen radical (ortho-position R₄, para-position R₃). These non-H radicals are selected from the group consisting of —(CH₂)ₙY, where Y=OH, CO₂H, NH₂, or Br and m=0 to 4. Preferably Y is OH or CO₂H. The groups in question are therefore groups which, as a result of the OH, CO₂H, NH₂ or Br, in particular, are more polar than is the case for pure alkyl radicals or hydrogen, for example. The polar group may be attached directly on the phenyl ring (m=0) or else may be linked via a methylene group (m=1) or ethylene group (m=2). It is also possible for a linear radical —(CH₂)—(CH₂)—(CH₂)— (m=3) or —(CH₂)—(CH₂)—(CH₂)—(CH₂)— (m=4) to be present as a bridging group. Preferably Y is OH or CO₂H. For m, preference is given to 0 or 1.

For preferred compounds (C), R₃ or R₄=H. With more particular preference, R₄=H and R₃=OH, CO₂H, CH₂OH, or CH₂CO₂H, especially preferably R₄=H and R₃=CO₂H or CH₂OH. The phenyl ring of the compound (C) is therefore preferably a phenyl ring substituted in para-position to the diaziridine ring.

### Method for Coating

The method of the invention for coating comprises, in its first embodiment (i), first of all the application of a carbene-forming compound (C) directly to a surface (O) of the plastics substrate, and the subsequent activation of the compound (C) to carbene formation. Only thereafter is the aqueous coating composition applied to the surface (O) of the plastics substrate and subsequently cured.

The application of a component, as for example of a compound (C) or of an aqueous coating composition, directly to a surface of a substrate is understood as follows: The respective component is applied such that the component following application is disposed on the surface of the substrate and is in direct contact with the surface. In particular, therefore, there is no other coat between the surface of the substrate and the coat formed by the component applied.

The application of a component, as for example of a compound (C) or an aqueous coating composition, to a substrate (without the particularization “directly”), is therefore understood as follows: The respective component is applied such that the component, following application, is disposed on the surface of the substrate, not necessarily with direct contact with the surface. There may, for example, also be other coats disposed between the surface of the substrate and the coat. Application without further particularization is therefore a generic term encompassing both direct and nondirect application.

For example, in the context of the first embodiment of the present invention, the compound (C) is applied directly to a surface (O) of the plastics substrate and then activated to carbene formation. If it is assumed that in this way a continuous coat is formed directly on the substrate, the immediate consequence of this is that the coating composition (A) which is applied subsequent to the application and activation of the compound (C) is no longer applied directly to the surface (O), since between them there is already a coat disposed.

The application of a component to a surface (O) of a substrate is synonymous with the formation of a coat or coating on the surface of the substrate. Such a coating will in general be continuous, in other words covering the entire surface. It may of course also be the case that a coating is not fully continuous, and so the entire surface of the substrate is not covered. Such coatings often result when only comparatively little material is applied. If the film thickness of a coat is specified in the context of the present invention, the reference is to the average film thickness.

To the skilled person it is clear that in the case of low average film thicknesses of, for example, less than 0.1 micrometer dry film thickness, it is no longer possible necessarily to assume a homogeneous coating.

A compound (C) may be applied by customary and known techniques. For example, a compound (C) may be dissolved in an organic solvent, preferably acetone, methyl ethyl ketone, cyclohexane and/or tetrahydrofuran, preferably methyl ethyl ketone, and then applied by customary application techniques such as spraying, pouring, dipping, impregnating, or trickling. Spray application is preferred. A compound (C) is applied preferably in the form of a solution in an organic solvent. The concentration of the solution may vary widely according to use, and may be situated, for example, in the range from 0.001 to 1 mol/l. The solution may of course also comprise more than one compound (C), in which case the stated concentration range stands for the total concentration of all compounds (C) present.

The applied solution of the compound (C) in an organic solvent is then flashed preferably for a duration of 1 to 60 minutes at room temperature (i.e., 10 to 40° C.). In the course of this procedure, at least the major part of the organic solvent is evaporated, leaving the compound (C) in finely divided form on the substrate.

Following the application and the optional flashing, the carbene-forming compound (C) is activated to carbene formation. Such activation, according to definition, comprises supply of thermal energy and/or exposure to electromagnetic radiation, preferably UV radiation. Connected inseparably to the activation, or encompassed by definition by the term “activation”, is also, therefore, the reaction of at least part of the compound (C), applied to a surface (O) of the plastics substrate, to give the carbene, with release of nitrogen. The fact that carbenes are formed from the compounds of the formula (C) under the stated activating conditions is known. Without wishing to be tied to any particular theory, it can be assumed at any rate that the carbenes formed, which as is known are very unstable, enter into reaction with the surface of the plastics substrate, for example, and thereby bring about a firm linkage to the substrate surface.

Activation may take place thermally (thermolysis). In that case, preferably, the compound (C) applied to the surface is treated for a duration of 5 to 120 minutes, preferably 20 to 60 minutes, at 60 to 140° C., preferably to 120° C. This may be done in conventional ovens, such as in a forced air oven, for example.

It will be appreciated that the temperature in this case is selected at any rate such that the particular plastics substrate selected retains its original form within the thermolysis described, and does not undergo deformation or decomposition. The skilled person knows at any rate the temperature at which a particular plastics substrate undergoes deformation, and/or the temperature at which softening of the material in question occurs. The corresponding conditions may therefore be adapted readily to the particular individual case.

Likewise possible is activation by exposure to electromagnetic radiation, more particularly UV radiation. Relevant UV radiation is typically in the spectral range from about 100 to 380 nanometers. UV radiation for activation may be generated, as is known, through the use of typical, commercially available mercury vapor lamps. The emission spectrum of such lamps is known to be a line spectrum with spectral lines in the UV range at about 184, 254, 297, 313, 334, and 365 nanometers. Such mercury vapor lamps are present in typically UV curing apparatus. Corresponding apparatus is available from IST Strahlentechnik Metz GmbH (Germany), for example, such as the model M-40-2*1-R-Ir-SLC-So-inert, UV lamp type (mercury vapor lamp type) M 400 U 2 H. The energy given off in irradiation is situated, for example, in the range from 500 to 3000 mJ per cm² of the substrate surface to which the compound (C) has been applied. This is achieved by UV irradiation of the substrates, using corresponding apparatus, for durations of 0.1 to 10 seconds for example, more particularly 1 to 5 seconds.

Application of the compound (C) is made such that following activation and the associated evaporation of organic solvents, there remains on the substrate a coat having a dry film thickness of, for example, 0.2 to 5 micrometers, preferably 0.3 to 3 micrometers. In the context of the present invention, dry film thicknesses have been determined by magnetoinductive measurement in accordance with DIN EN ISO 2178. The application of this measurement technique, designed for ferromagnetic substrates, has been made possible as follows: besides the respective plastics substrate, a metallic substrate was coated at the same time or in parallel, in the same way in each case. The film thicknesses measured on the metallic substrate were then equated with the film thicknesses on the plastics substrate.

Subsequent to the application and activation of the at least one compound (C), the coating composition (A) as described above is applied to the already coated surface (O) of the substrate. The coating composition (A) is preferably applied directly to the coat obtained following application and activation of the compound (C).

The application of the aqueous coating composition may take place by all customary application techniques, such as, for example, spraying, knifecoating, spreading, pouring, dipping, impregnating, trickling or rolling, preferably by means of spray application. In the course of such application, the plastics substrate to be coated may per se be at rest, with the application equipment or unit being moved. Alternatively the substrate to be coated may be moved, with the application unit being at rest relative to the substrate or being moved in an appropriate way. Preference is given to employing spray application methods, such as, for example, compressed air spraying (pneumatic application), airless spraying, high-speed rotation, electrostatic spray application (ESTA), optionally in conjunction with hot spray application such as hot air spraying, for example.

The aqueous coating composition applied to the surface (O) of the plastics substrate (or directly to the coat obtained by application and activation of compound (C)) is cured, thereby producing a cured coating. Curing of the applied aqueous coating composition has no peculiarities in terms of method, but instead takes place in accordance with the customary and known techniques such as, for example, heating in a forced air oven or by irradiation with IR lamps. Also possible is actinic curing by means, for example, of UV radiation in the case of radiation-curing systems. The curing conditions, more particularly the curing temperatures, are guided, for example, by the temperature sensitivity of the plastics substrates used and also by the aqueous coating compositions that are used—in accordance, for example, with whether the particular aqueous coating composition used comprises self-crosslinking or externally crosslinking binders and optionally crosslinkers. Thus curing may take place, for example, in the region of the room temperature or else at elevated temperatures in the range of, for example, 40° C. to 120° C., preferably from 60° C. to 100° C. The period of the curing phase as well is selected individually and is dependent on factors including those already specified above (for example, choice of binders and/or of curing temperatures). Curing may take place, for example, over a time of 5 minutes to 120 minutes, preferably 10 minutes to 40 minutes. Curing may optionally also be preceded by a flashing phase or preliminary drying phase, at room temperature for a period of 1 to 60 minutes, for example. The particular curing conditions to be applied in the case of particular substrates and/or coating compositions are part of the general art knowledge, and so the conditions may be adapted and selected by the skilled person.

The aqueous coating composition is applied in the customary and known film thicknesses, as for example in wet film thicknesses of 10 to 200 micrometers, preferably of 50 to 150 micrometers. The resultant dry film thicknesses after curing are then, for example, in the range from 2 to 40 micrometers, more particularly 5 to 20 micrometers.

In accordance with a second embodiment (ii) of the present invention, the coating composition (A) comprises at least one carbene-forming compound (C). In this embodiment, the carbene-forming compound (C) described as above is activated to carbene formation at any rate after the application of the coating composition (A). This means, accordingly, that in this embodiment the curing conditions may be selected such that activation occurs likewise in the course of curing. It follows from the above that in this case, accordingly, the curing takes place preferably at temperatures of preferably 60 to 100° C. over a time of 5 to 120 minutes, since then it is possible for thermolytic activation of the carbene-forming compound (C) to result at the same time. Of course, the activation may also take place before, during or after the curing, photolytically, or there may be combined activation by thermolysis and photolysis. The latter is the case especially when during the curing initiated by heat (thermal energy), the applied coating composition is also exposed to electromagnetic radiation, more particularly UV radiation. For the photolytic activation, the preferred conditions already specified above for embodiment (i) are applicable.

If exclusively the second embodiment is employed, and in other words, in particular, there is no combination of first and second embodiments, the coating composition (A) is preferably applied directly to the surface (O) of the plastics substrate.

Otherwise, the application and curing of the coating composition (A), in the context of the embodiment (ii), are subject in principle to the statements made above in relation to embodiment (i).

Embodiment (i) of the present invention is preferred. In that way, particularly effective adhesion is achieved.

A further subject of the present invention is a coated plastics substrate which has been coated by the method of the invention.

Further coatings may be produced atop the coated plastics substrate as hitherto described.

In one preferred embodiment of the invention, another coating composition is applied and cured on the coated plastics substrate as hitherto described, and a further cured coating is produced. More particularly this is a clearcoat material and a clearcoat, respectively. As is known, a clearcoat material is a coating material which following application and curing forms a transparent coating (the clearcoat) having protective and/or decorative properties. By protective properties are meant, for example, scratch resistance and weathering stability, more particularly UV stability. An example of a decorative property is a good gloss. The clearcoat materials for use are the clearcoat materials which are customarily used in the art of plastics painting, and their selection and use is known to the skilled person (in this regard see also Römpp-Lexikon Lacke and Druckfarben, Georg Thieme Verlag, Stuttgart, New York, 1998, page 325). The general application and curing techniques for the further coating composition, more particularly the clearcoat material, correspond to those as described earlier on above for the aqueous coating composition. A coating of this kind which may then be referred to as a classic multicoat coating system is produced preferably by wet-on-wet painting. This means that the further coating composition, more particularly the clearcoat material, is applied to the applied aqueous coating composition (A) without the latter being cured separately beforehand. The two applied coating compositions are then cured jointly, resulting in the classic multicoat coating system. It follows from what has been said above that especially in the context of the wet-on-wet variant, the clearcoat material is applied preferably directly to the coat produced by the coating composition (A). The compound (C), as part of the embodiment (ii), may accordingly be activated to carbene formation before, during, or after the application of the clearcoat material.

The further coating composition, more particularly the clearcoat material, is applied in the customary and known film thicknesses, as for example in wet film thicknesses of 50 to 250 micrometers, preferably of 100 to 180 micrometers. The resulting dry film thicknesses in this case, after curing, are then, for example, in the range from 15 to 80 micrometers, more particularly 25 to 50 micrometers.

Overall, therefore, the coated plastics substrates coated by the method of the invention are suitable for the esthetically and technically demanding field of vehicle finishing, more particularly of automotive finishing. The coated plastics substrates, more particularly the plastics substrates coated with a multicoat coating system, can be used as vehicle parts and vehicle accessory parts and parts for installation in and on vehicles, for both the interior area and the exterior area of vehicles. In addition to outstanding adhesion of the coatings or multicoat coating systems produced, it is possible, furthermore, to achieve a good and variable decorative effect.

The coatings or paint films produced by the method of the invention for coating plastics substrates possess, furthermore, an excellent adhesion.

It also follows from the above that the use of compounds of the formula (I) for improving the adhesion of coatings disposed on plastics substrates and produced by means of aqueous coating compositions is a subject of the present invention.

The invention is elucidated in more detail by means of the examples which follow.

### EXAMPLES

Various plastics substrates, in each case in the form of test plaques having a size of 10×10×0.3 cm or 100×100×3 cm, were coated with different aqueous coating compositions. The plastics materials used were PP sheets (Daplen™ EE103AE (Borealis)).

### A) Coating of Plastics Substrates

A plastics substrate was coated using the coating compositions identified in tables 1 and 2 (see also associated explanations). Prior to application with these coating compositions, the substrate was treated as described below with a solution of 4-[3-(trifluoromethyl)-3H-diazirin-3-yl]benzoic acid (compound (C), where R₁=CF₃ and in R₂ the following is the case: R₃=COOH, R₄=H) (0.005 mol/l in methyl ethyl ketone).

The aqueous coating composition (A) used for coating was the aqueous basecoat material having the composition according to table 1. The basecoat material was prepared by combining and intimately mixing the components indicated in table 1, in a dissolver.

TABLE 1
Composition of the aqueous basecoat
material used

| | Parts by |
|---|---|
| Component | weight used |
| Commercial thixotropic agent | 18.2 |
| (Laponite RD) | |
| Commercial dispersion of an OH- | 31.9 |
| functional polyurethane resin | |
| (water content: 66.0% by weight, | |
| organic solvents: 6.3% by | |
| weight) | |
| TMDD BG 52 (commercial wetting | 0.5 |
| agent) | |
| Commercial dispersion of an OH- | 3.0 |
| functional polyester resin | |
| (water content: 17.7% by weight, | |
| organic solvents: 20.0% by | |
| weight) | |
| Butoxypropanol | 2.0 |
| Cymel 327 (commercial melamine- | 4.2 |
| formaldehyde resin) | |
| Neutralizing solution | 0.7 |
| (dimethylethanolamine, 10% in | |
| water) | |
| Commercial dispersion of an OH- | 5.1 |
| functional acrylate resin (water | |
| content: 49.5% by weight, | |
| organic solvents: 13.0% by | |
| weight) | |
| Water | 2.1 |
| Foamstar MF324 (commercial | 0.5 |
| defoamer) | |
| Ethylhexanol | 3.9 |
| BYK 347 (commercial wetting | 0.5 |
| agent) | |
| Pluriol P900 (commercial | 2.0 |
| polyethylene glycol) | |
| Butyldiglycol | 4.7 |
| Isopropanol | 2.1 |
| Water | 1.8 |
| Neutralizing solution | 0.8 |
| (dimethylethanolamine, 10% | |
| in water) | |
| Water | 2.2 |
| Viscalex HV 30 (commercial | 0.4 |
| rheological agent) | |
| Water | 2.0 |
| Tinting paste 1 (10% dispersion | 10.1 |
| of Monarch 1400 carbon black | |
| pigment in water) | |
| Tinting paste 2 (50% dispersion | 0.1 |
| of titanium rutile 2310 pigment | |
| in water) | |
| Water | 1.2 |

Additionally used was a commercial clearcoat material (see table 2), which was produced by combining and intimately mixing the components specified in table 2, in a dissolver.

TABLE 2
Composition of the clearcoat material used

| | Amount (in % |
|---|---|
| Component | by weight) |
| Commercial dispersion of an OH-functional | 50.9 |
| acrylate resin in organic solvents | |
| Setal 82166 SS-55 | 25.5 |
| Cyclohexanone | 3.9 |
| Solvent Naphtha 230/290 | 2.0 |
| Commercial dispersion of an OH-functional | 9.8 |
| acrylate resin in organic solvents | |
| Disolucion de Silicona F-2 | 1.5 |
| 5% strength solution of Baysilon OL44 | 0.5 |
| Tinuvin 292 (commercial light stabilizer) | 0.9 |
| Tinuvin 1130 (commercial UV absorber) | 0.9 |
| 1% strength solution of dibutyltin | 0.6 |
| laurate | |
| Cumyl hydroperoxide (80% form) | 0.4 |
| 1-Methoxyprop-2-yl acetate | 3.1 |

The actual production of coatings took place as follows.

First of all, by means of spray application, the solution comprising the diaziridine-containing compound (C) was applied directly to a plastics substrate.

This was followed initially by matt flashing (5 minutes at 20° C.), after which the applied diaziridine-containing compound was treated or activated with UV radiation (2837 mJ per cm² of plastics substrate). Activation took place using a UV curing apparatus from IST Strahlentechnik Metz GmbH (model type M-40-2*1-R-Ir-SLC-So-inert, UV lamp type (mercury vapor lamp type) M 400 U 2 H with a typical UV emission line spectrum with spectral lines from 184 to 365 nanometers.

Applied pneumatically directly atop the substrate thus precoated was the aqueous basecoat material (table 1), followed by flashing at 20° C. for 5 minutes. Thereafter the clearcoat material (table 2) was pneumatically applied directly and flashed at 20° C. for 10 minutes. Curing was carried out subsequently at a temperature of 80° C. over a duration of 30 minutes. The dry film thicknesses of the individual coats in the multicoat coating system (E1) produced in accordance with the invention were 2 micrometers (coat based on the diaziridine-containing compound), 15 micrometers (basecoat), and 42 micrometers (clearcoat).

In addition to the multicoat coating system (E1), further multicoat coating systems were produced by analogy with the instructions given above. In the multicoat coating system (E2), however, a different compound (C) was used, namely 4-[3-(trifluoromethyl)-3H-diazirin-3-yl]benzyl alcohol (compound (C), where R₁=CF₃ and in R₂ the following is the case: R₃=CH₂—OH, R₄=H). In the comparative multicoat coating system (V1), no compound (C) was used, the carbene instead being 3-phenyl-3-(trifluoromethyl)-3H-diaziridine (compound similar to formula (I), but with R₁=CF₃ and the following being the case in R₂: R₃=R₄=H). In the case of the production of the multicoat coating systems (V2) and (V3), the application and activation of a compound (C) was likewise omitted. However, no carbene at all was used (the steps of the corresponding application and activation were therefore dropped). Whereas in the case of (V2) merely the stated steps were dropped, the plastics substrate in the case of the multicoat coating system (V3), instead of the application and activation of the aforementioned diaziridine-containing compound (C), was pretreated, prior to the application of the basecoat material (A), by customary flaming (by means of a commercial automatic flaming device from Kirchgässner Elektrotechnik).

Table 3 shows an overview of the multicoat coating systems produced. All multicoat coating systems comprise a basecoat and a clearcoat.

TABLE 3
Multicoat coating systems

| Multicoat | |
|---|---|
| coating system | Specification |
| (E1) | 4-[3-(Trifluoromethyl)-3H-diazirin-3- |
| | yl]benzoic acid |
| | (compound (C), where R₁ = CF₃ and in R₂: |
| | R₃ = COOH, R₄ = H) |
| (E2) | 4-[3-(Trifluoromethyl)-3H-diazirin-3- |
| | yl]benzyl alcohol |
| | (compound (C), where R₁ = CF₃ and in R₂: |
| | R₃ = CH₂—OH, R₄ = H) |
| (V1) | 3-Phenyl-3-(trifluoromethyl)-3H- |
| | diaziridine |
| | (compound similar to formula (I), but |
| | where R₁ = CF₃ and in R₂: R₃ = R₄ = H) |
| (V2) | No carbene |
| (V3) | No carbene, but flaming |

### B) Investigation of the Adhesion Properties of Coatings

The adhesion properties of the coatings produced were investigated by way of a widely known steam jet test (DIN 55662:2009-12, 1 minute of steam jetting at 60° C., pressure 67 bar, vertical distance from test specimen 10 cm).

The adhesion was evaluated using a whole-number rating system with ratings of 0-5, the rating 0 being awarded for coatings which had no visible traces after steam jet treatment (very good adhesion), and the rating 5 being awarded for coatings which after the steam jet test had very comprehensively detached regions (insufficient adhesion).

Table 4 shows the adhesion properties of the coatings produced in relation to the plastics substrates used and their pretreatment.

TABLE 4
Adhesion properties of the multicoat
coating systems

| Multicoat | |
|---|---|
| coating system | Adhesion result |
| (E1) | 0 |
| (E2) | 0 |
| (V1) | 5 |
| (V2) | 5 |
| (V3) | 2 |

The results show that the multicoat coating systems constructed in accordance with the method of the invention have a significantly better adhesion than is the case for the multicoat coating systems (V1) and (V2) (omission of the use of a compound (C) or of any carbene at all). The comparison with the results for the multicoat coating system (V3), moreover, also demonstrates the surprising advantage of the method of the invention in the context in particular of the coating of nonpolar plastics substrates (in this case, PP). In spite of the substitution of conventional flaming for application and activation of a compound (C), the adhesion of the multicoat coating system (V3) is significantly poorer than is the case for the very effectively adhering multicoat coating systems (E1) and (E2).

1. A method for coating plastics substrates with an aqueous coating composition (A) comprising at least one organic polymer as binder, said coating composition being applied to at least one surface (O) of the plastics substrate and being subsequently cured,
wherein
(i) the application of the coating composition (A) is preceded by the application of a carbene-forming compound (C) of the formula (I) below 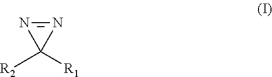
where
R₁=—(CX₂)ₙX, where X=F or Cl, and n=0 or 1,
R₂= 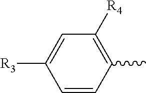
where
R₃ and R₄ independently of one another =—H, —(CH₂)ₘY, where Y=OH, CO₂H, NH₂, or Br, and m=0 to 4,
with the exception of R₃=R₄=—H,
directly to the surface (O) and its activation to carbene formation, and/or (ii) the coating composition (A) comprises the carbene-forming compound (C), which is activated to carbene formation following application of the coating composition (A).

2. The method as claimed in claim 1, wherein the aqueous coating composition comprises a total fraction of 15 to 60 wt %, based on the total amount of the coating composition, of at least one organic, OH-functional polymer as binder and at least one crosslinker selected from the group of fully etherified and/or partially etherified amino resins, monomeric and/or polymeric polyamines and/or monomeric and/or polymeric, blocked and/or free polyisocyanates.

3. The method as claimed in claim 1, wherein the aqueous coating composition comprises at least 20 wt % of water, based on the total amount of the coating composition.

4. The method as claimed in claim 1, wherein the aqueous coating composition is a pigmented basecoat material.

5. The method as claimed in claim 1, wherein the plastics substrate comprises plastics selected from the group consisting of polystyrene (PS), polyvinyl chloride (PVC), polyurethane (PU), glass fiber-reinforced unsaturated polyesters, polymethyl methacrylate (PMMA), polyphenylene sulfide (PPS), polyoxymethylene (POM), polyphenylene ethers (PPE), polyphenylene oxide (PPO), polyurea, polybutadiene terephthalate (PBT), polycarbonate (PC), acrylonitrile-butadiene-styrene copolymers (ABS), polyolefins such as polypropylene (PP), optionally modified with ethylene-propylene-diene copolymers (EPDM), and also mixtures of these plastics.

6. The method as claimed in claim 1, wherein for the compound (C) of the formula (I) it is the case that R₁=—CF₃, R₃=—OH, —CO₂H, —CH₂OH, —CH₂CO₂H, and R₄=—H.

7. The method as claimed in claim 1, wherein for the compound (C) of the formula (I) it is the case that R₁=—CF₃, R₃=—CO₂H or —CH₂OH, and R₄=—H.

8. The method as claimed in claim 1, wherein the activation of the compound (C) to carbene formation comprises exposing the compound (C) to UV radiation.

9. The method as claimed in claim 1, wherein the application of the coating composition (A) is preceded by the application of the carbene-forming compound (C) directly to the surface (O) of the substrate and its activation to carbene formation.

10. The method as claimed in claim 9, wherein the compound (C) is applied in the form of a solution in an organic solvent.

11. The method as claimed in claim 1, wherein following the application of the aqueous coating composition (A), at least one further coating composition is applied and is cured jointly with the applied coating composition (A), at least one of the further coating compositions being a clearcoat material.

12. A coating produced by a method as claimed in claim 1.

13. A coated plastics substrate which has been coated by the method as claimed in claim 1.

14. The coated plastics substrate as claimed in claim 13, which is coated with a multicoat coating system comprising a basecoat and a clearcoat.

15. The use of a compound (C) of the formula (I) below 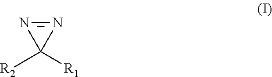
where
R₁=—(CX₂)ₙX, where X=F or Cl, and n=0 or 1,
R₂= 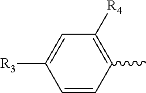
where
R₃ and R₄ independently of one another =—H, —(CH₂)ₘY, where Y=OH, CO₂H, NH₂, or Br, and m=0 to 4,
with the exception of R₃=R₄=—H,
for improving the adhesion of coatings on plastics substrates that have been produced by means of aqueous coating compositions.
